(19) United States
(12) Patent Application Publication
(10) Pub. No.: US 2015/0060553 A1
(43) Pub. Date: Mar. 5, 2015

(54) SELF-ADHESIVE TYPE RADIO FREQUENCY ANTI-COUNTERFEITING AND ANTI-RECLAMATION LABEL

(71) Applicants: SHENG-CHANG HUANG, KAOHSIUNG CITY (TW); SUPREME TECHNIC PACKAGE CO., LTD., KAOHSIUNG CITY (TW)

(72) Inventor: SHENG-CHANG HUANG, KAOHSIUNG CITY (TW)

(73) Assignees: SUPREME TECHNIC PACKAGE CO., LTD., KAOHSIUNG CITY (TW); SHENG-CHANG HUANG, KAOHSIUNG CITY (TW)

(21) Appl. No.: 14/018,018

(22) Filed: Sep. 4, 2013

(51) Int. Cl. G06K 19/077; G06K 19/02

(52) U.S. Cl. CPC G06K 19/07798; G06K 19/025; G06K 19/0776; G06K 19/07722; G06K 2019/06253
USPC 235/488

(57) ABSTRACT

A self adhesive type radio frequency anti-counterfeiting and anti-reclamation label includes a self-adhesive label provided with characters or patterns and has its inner surface formed with a gluing layer. A radio frequency identification system is installed at the outer side of the gluing layer and provided with a foundation plate mounted with a radio frequency chip and an antenna serving as a passive source signals sent out by the identification chip. A tearing region is formed between the label and the radio frequency identification system for receiving therein the radio frequency identification system, the antenna or the identification chip. The label can be torn up, or the tearing region can be torn off manually to separate the label from the radio frequency identification system, or separate the identification chip from the antenna, letting the original label impossible to be recycled for attaining an objective of anti-counterfeiting.

### FILED OF THE INVENTION

This relates to a self-adhesive type radio frequency anti-counterfeiting and anti-reclamation label, particularly to one able to be stuck to containers or various kinds of packages. A tearing region is provided between a label and a radio frequency identification system for receiving therein the radio frequency identification system or an antenna or an identification chip. Thus, the label can be destroyed and torn up manually or the tearing region can be torn off to separate the label from the radio frequency identification system or separate the identification chip from the antenna at the same time, letting the original label impossible to be recycled and thus attaining an objective of anti-counterfeiting and anti-reclamation.

### DESCRIPTION OF THE PRIOR ART

Generally, the packages or the containers of all kinds of commodities are usually stuck thereon with a self-adhesive label so that consumers can conveniently recognize the manufacturing source of the commodities. However, the self-adhesive labels adhering to the packages or containers can be printed conveniently and have no other anti-forgery features; therefore, lawbreakers have an opportunity to fake labels and mix the spurious with the genuine for obtaining illegal interests but consumers are not aware whether the commodities they purchased are genuine or out, resulting in consumers' misgivings in purchasing merchandise and consumption security.

Therefore, the inventor of this invention with many years of experience in manufacturing and designing related products of radio frequency identification system has been engaged in research for the problem of self-adhesive labels in use and devises this invention.

### SUMMARY OF THE INVENTION

The objective of this invention is to offer a self-adhesive type radio frequency anti-counterfeiting and anti-reclamation label provided with an identification chip for revealing the curriculum vitae of a commodity and formed with a tearing region to be torn down or destroyed for preventing the label from being faked or being recycled.

The self-adhesive type radio frequency anti-counterfeiting and anti-reclamation label in the present invention is provided with a pattern layer and has its inner surface disposed with a gluing layer. A radio frequency identification system is installed at the outer side of the gluing layer of the label, provided with a foundation plate set thereon with an identification chip and an antenna that serves as a passive source of signals sent out by the identification chip. A tearing region is formed between the label and the radio frequency identification system, and the radio frequency identification system, the antenna or the identification chip is positioned within the tearing region. The label can be destroyed or torn up manually, or the tearing region can be torn apart to have the label separated from the radio frequency identification system or to have the identification chip separated from the antenna at the same time, letting the original label impossible to be recycled and thus achieving an objective of anti-counterfeiting.

### BRIEF DESCRIPTION OF DRAWINGS

This invention will be better understood by referring to the accompanying drawings, wherein:

FIG. 1 is a cross-sectional view of a first preferred embodiment of a self-adhesive label combined with a radio frequency identification system in the present invention;

FIG. 2 is a cross-sectional view of a second preferred embodiment of a self-adhesive label combined with a radio frequency identification system in the present invention;

FIG. 3 is a front view of a first preferred embodiment of a label in the present invention;

FIG. 4 is a rear view of the first preferred embodiment of the label in the present invention;

FIG. 5 is a rear view of a second preferred embodiment of a label in the present invention;

FIG. 6 is a rear view of a third preferred embodiment of a label in the present invention;

FIG. 7 is a schematic view of a first preferred embodiment of a tearing region in the present invention;

FIG. 8 is a schematic view of a second preferred embodiment of a tearing region in the present invention;

FIG. 9 is a schematic view of a third preferred embodiment of a tearing region in the present invention;

FIG. 10 is a schematic view of a fourth preferred embodiment of a tearing region in the present invention; and

FIGS. 11A-11C are schematic views of the self-adhesive type radio frequency anti-counterfeiting and anti-reclamation label in a using condition in the present invention.

### DETAILED DESCRIPTION OF THE PREFERRED EMBODIMENT

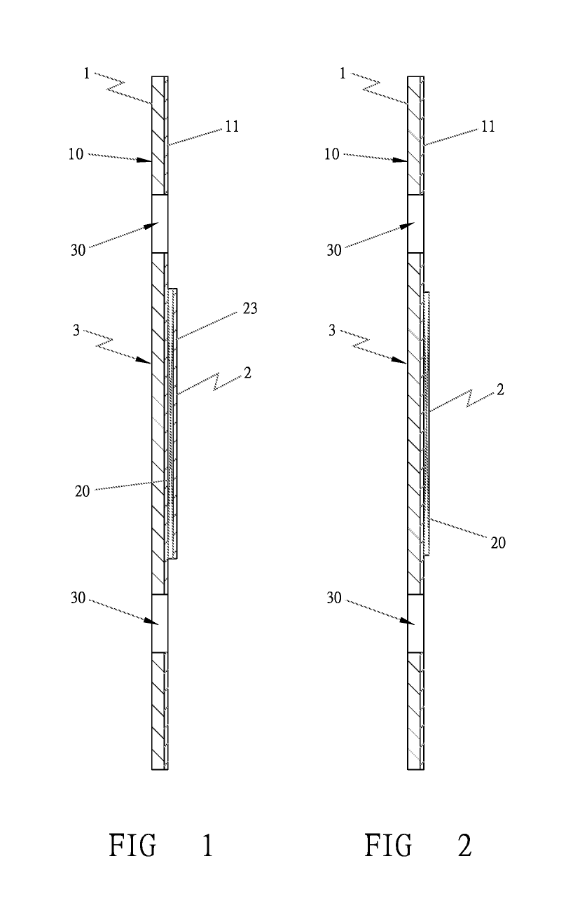

A first preferred embodiment of a self-adhesive type radio frequency anti-counterfeiting and anti-reclamation label in the present invention, as shown in FIGS. 1 and 2, includes a label 1, which is a self-adhesive label, a radio frequency identification system 2 and a tearing region 3 combined together. The label 1 is provided with characters or patterns or a design layer 10 of characters and patterns. The label 1 has its inner surface formed with a gluing layer 11, which is further disposed with a separable layer.

Referring to FIGS. 1 and 2, the radio frequency identification system 2 is installed at the outer side of the gluing layer 11 of the label 1 and provided with a foundation plate 20 disposed thereon with an identification chip 21 and an antenna 22 that serves as a passive source of signals sent out by the identification chip 21. The radio frequency identification system 2 can have its surface provided with a gluing layer 23, as shown in FIG. 1 or provided with no gluing layer 23, as shown in FIG. 2. The gluing layer 23 of the radio frequency identification system 2 is to cooperate with the gluing layer 11 on the inner surface of the label 1 for adhering to the packages on the containers of commodities; therefore, if the radio frequency identification system 2 has no gluing layer 23 provided on the surface, the tearing region 23 can produce a floating attached effect for facilitating the tearing region 3 to be torn away from the label 1. The radio frequency identification system 2 can be provided with one single identification chip of high frequency or ultra high frequency, or provided with two identification chips respectively of high frequency or ultra high frequency, or both are of high frequency or of ultra high frequency. The antenna 22 can be one single loop circuit, or two loop circuits or more than two loop circuits.

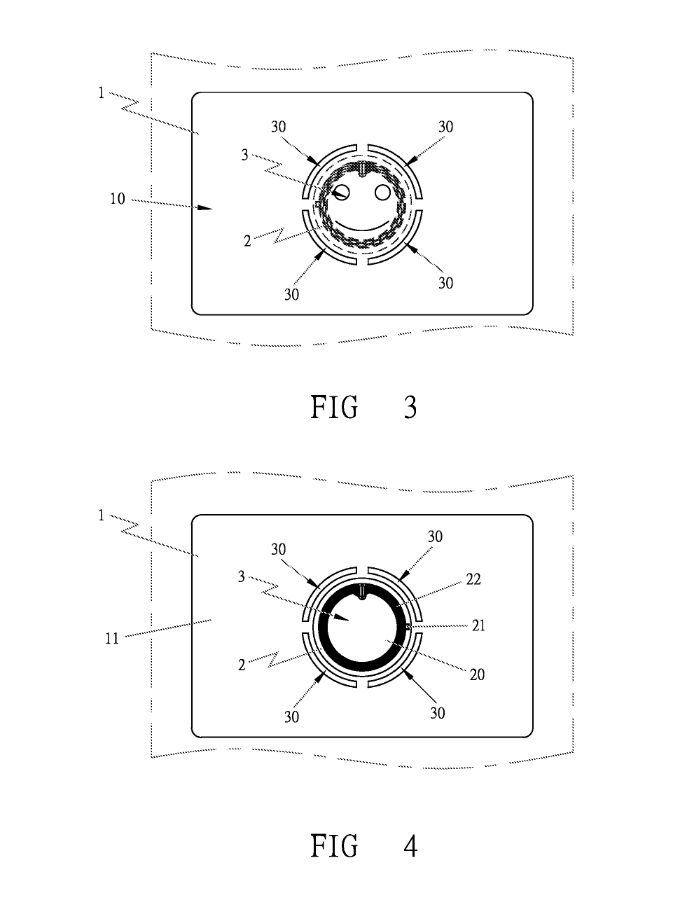

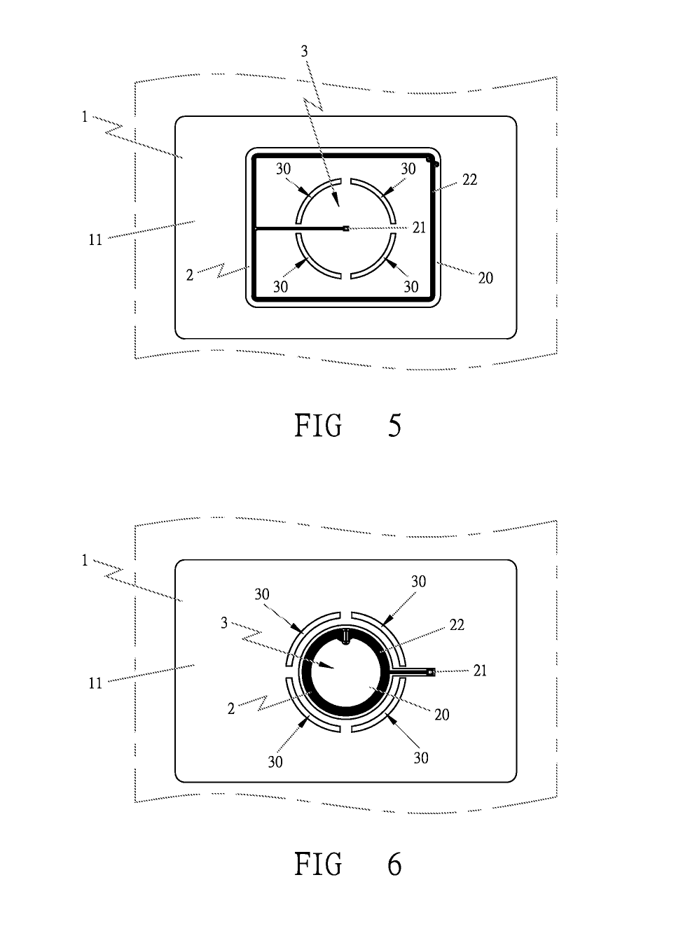

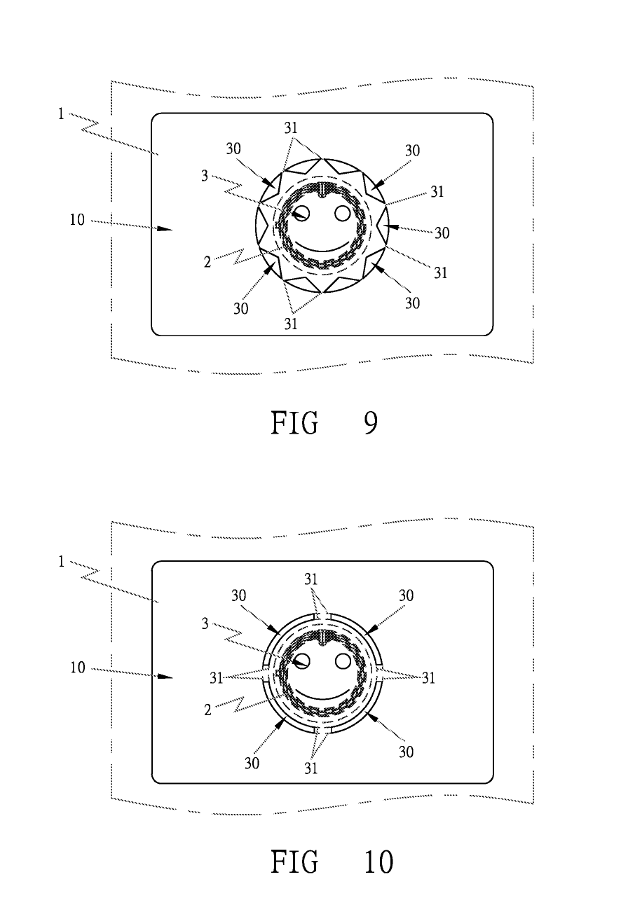

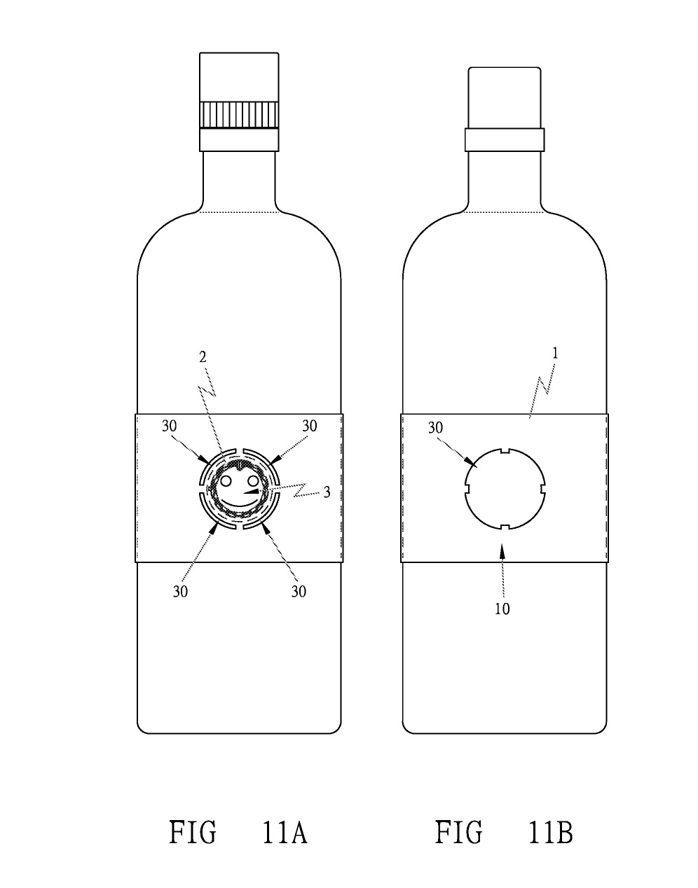

Referring to FIGS. 2 and 3, the tearing region 3 is provided between the label 1 and the radio frequency identification system 2 for the radio frequency identification system 2, the identification chip 21 or the antenna 22 to be positioned therein. The formation of the tearing region 3 is to form tearing holes 30, as shown in FIGS. 4-7, or tearing lines 31, or tearing holes and tearing lines, as shown in FIGS. 8-10, between the label 1 and the tearing region 3. Thus, before purchasing a commodity, a consumer can employ an intelligent mobile device to read the contents of the commodity by the identification chip 21, or after purchasing, the consumer can employ an intelligent mobile device to directly read the identification chip 21 for connecting to the data bank of the manufacturer for realizing the curriculum vitae of the commodity. After the commodity is used, the label 1 can directly be torn off manually, as shown in FIGS. 4-6 and 8-10, or the tearing region 3 can be torn apart, as shown in FIG. 7, to have the label separated from the radio frequency identification system, or have the identification chip separated from the antenna at the same time, letting the original label impossible to be recycled and thus attaining an objective of anti-counterfeiting.

Referring to FIGS. 3, 4 and 8-10, the radio frequency identification system 2 is installed within the tearing region 3 so that a consumer can make use of the tearing holes 30 or the tearing line 31 or both the tearing holes and the tearing lines of the tearing region 3 to tear down the label 1 and leave the tearing region 3, or utilize the tearing holes 30 or the tearing lines 31 or both the tearing holes 30 and the tearing lines 31 to tear apart the tearing region 3 and leave the label 1. Since the radio frequency identification system 2 is provided with no gluing layer 23 on the surface to let the tearing region 3 form a floating attached state, therefore, the tearing region 3 can conveniently be torn down from the label 1, as shown in FIG. 2.

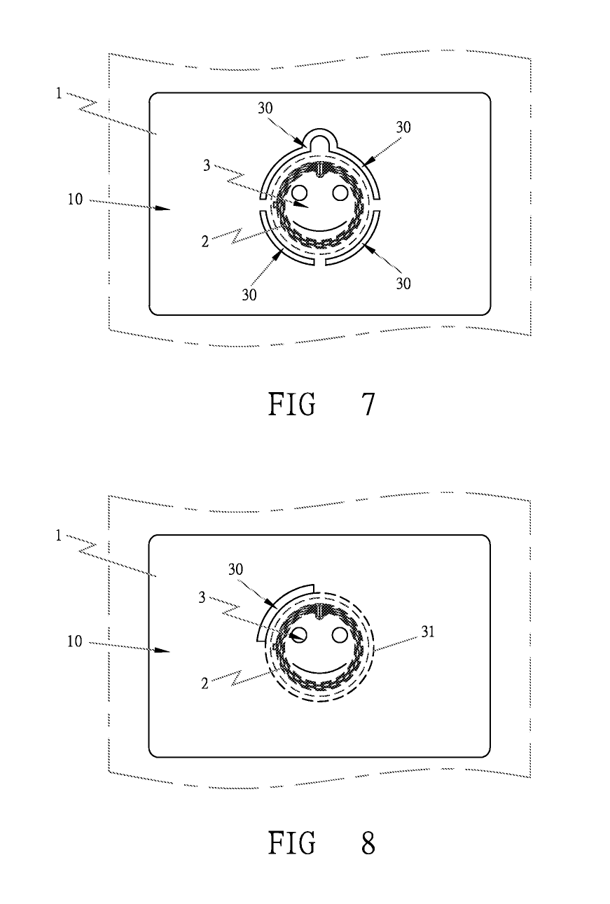

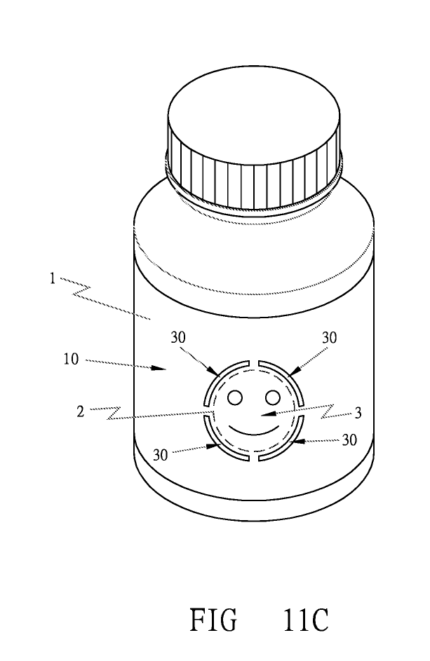

FIG. 5 shows that the identification chip 21 of the radio frequency identification system 2 is installed within the tearing region 3 while the antenna 22 is extended out of the tearing region 3, and FIG. 6 shows that the antenna 22 of the radio frequency identification system is positioned within the tearing region 3 while the identification chip 21 is installed out of the tearing region 3. Thus, a consumer can tear down the label 1 and leave the tearing region 3 by making use of the tearing holes 30 or the tearing lines 31 or both the tearing holes 30 and the tearing lines 31 of the tearing region 3, or tear off the tearing region 3 and leave the label 1 by utilizing the tearing holes 30, the tearing lines 31 or the tearing holes 30 and the tearing lines 31. At this time, since no gluing layer 23 is provided no the surface of the radio frequency identification system 2 to let the tearing region 3 form a floating attached state; therefore, the tearing region 3 can be conveniently torn away from the label 1, as shown in FIG. 2, to force the antenna 22 to be separated from the identification chip 21 and directly destroy the structure of the radio frequency identification system 2, thus equally able to attain an objective of anti-counterfeiting and anti-reclamation, as shown in FIG. 11B. Of course, FIGS. 5 and 6 can be applied to all the preferred embodiments of FIGS. 3, 4 and 7-10.

To sum up, the self-adhesive type radio frequency anti-counterfeiting and anti-reclamation label in the present invention can be stuck to packages or containers, as shown in FIGS. 11A-11C. Since the identification chip and the antenna of the radio frequency identification system are installed within the tearing region of the label; therefore, through the conditions between the label and the tearing region, the structure of the self-adhesive type radio frequency anti-counterfeiting and anti-reclamation label can be changed to directly destroy the integrity of the label. In addition, consumers are able to understand the curriculum vitae of the commodities by means of the identification chip and even after purchasing, consumers can directly enter a manufacturer's data bank for judging whether the commodity is genuine or not, able to prevent illegal fakes from seizing the markets.

While the preferred embodiments of the invention have been described above, it will be recognized and understood that various modifications may be made therein and the appended claims are intended to cover all such modifications that may fall within the spirit and scope of the invention.

What is claimed is:

1. A self-adhesive type radio frequency anti-counterfeiting and anti-reclamation label at least comprising:
a label, said label provided with characters or patterns or a design layer of characters and patterns, said label formed with a gluing layer at an inner surface;
a radio frequency identification system installed at an outer side of said gluing layer of said label, said radio frequency identification system disposed with a foundation plate, said foundation plate provided thereon with an identification chip and an antenna, said antenna serving as a passive source signals sent out by said identification chip; and
a tearing region formed between said label and said radio frequency identification system, said radio frequency identification system or said antenna or said identification chip positioned within said tearing region, said label able to be destroyed and torn up manually, said tearing region able to be torn off manually to have said label separated from said radio frequency identification system or to have said identification chip separated from said antenna, letting said original label impossible to be recycled for attaining an objective of anti-counterfeiting.

2. The self-adhesive type radio frequency anti-counterfeiting and anti-reclamation label as claimed in claim 1, wherein said radio frequency identification system is installed at an outer side of said gluing layer of said label and has an outer surface provided with a gluing layer.

3. The self-adhesive type radio frequency anti-counterfeiting and anti-reclamation label as claimed in claim 1, wherein said radio frequency identification system is installed at the outer side of said gluing layer of said label and provided with no gluing layer on the surface.

4. The self-adhesive type radio frequency anti-counterfeiting and anti-reclamation label as claimed in claim 1, wherein said tearing region is formed between said label and said radio frequency identification system and formation of said tearing region is to form tearing holes between said label and said tearing region.

5. The self-adhesive type radio frequency anti-counterfeiting and anti-reclamation label as claimed in claim 1, wherein said tearing region is positioned between said label and said radio frequency identification system and formation of said tearing region is to form tearing lines between said label and said tearing region.

6. The self-adhesive type radio frequency anti-counterfeiting and anti-reclamation label as claimed in claim 1, wherein said tearing region is disposed between said label and said radio frequency identification system and is made up of tearing holes and tearing lines located between said label and said tearing region.

7. The self-adhesive type radio frequency anti-counterfeiting and anti-reclamation label as claimed in claim 1, wherein said identification chip of said radio frequency identification system is set within said tearing region, while said antenna is extended out of said tearing region, said tearing holes or said tearing lines or both said tearing holes and said tearing lines utilized to tear down said label and leave said tearing region or to tear off said tearing region and leave said label to have said antenna separated from said identification chip and directly destroyed the structure of said radio frequency identification system for attaining objectives of anti-counterfeiting and anti-reclamation.

8. The self-adhesive type radio frequency anti-counterfeiting and anti-reclamation label as claimed in claim 1, wherein said antenna of said radio frequency identification system is mounted within said tearing region, while said identification chip is arranged at an outer side of said tearing region, said tearing holes or said tearing lines or both said tearing holes and said tearing lines utilized to tear down said label and retain said tearing region, or to tear off said tearing region and retain said label to have said antenna separated from said identification chip for directly destroying the structure of said radio frequency identification system, able to equally attaining objectives of anti-counterfeiting and anti-reclamation.
